(19) United States
(12) Patent Application Publication
(10) Pub. No.: US 2002/0150521 A1
(43) Pub. Date: Oct. 17, 2002

(54) Transportation of hydrogen fluoride

(75) Inventors: Robert B. Eldridge, Bartesville, OK (US); Bruce B. Randolph, Bartlesville, OK (US); Richard L. Anderson, Bartlesville, OK (US)

Correspondence Address: Richmond, Hitchcock, Fish & Dollar, P.O. Box 2443, Bartlesville, OK, 74005, US

(73) Assignee: Phillips Petroleum Company, Bartlesville, OK (US)

(21) Appl. No.: 10/062,858

(22) Filed: Feb. 5, 2002

Related U.S. Application Data
(62) Division of application No. 08/448,697, filed on May 24, 1995, now abandoned.
Application No. 08/448,697 is a continuation-in-part of application No. 08/234,453, filed on Apr. 28, 1994, now abandoned.

(51) Int. Cl. B01J 4/00

(52) U.S. Cl. 422/187; 423/265; 502/500; 502/216

(57) ABSTRACT

An improved method for the safe storage, transportation, and handling of hydrogen fluoride.

This is a continuation-in-part of application Ser. No. 08/234,453, filed Apr.28, 1994.

The present invention relates to an improvement in the safety of the handling and transportation of hydrogen fluoride.

### BACKGROUND OF THE INVENTION

Hydrogen fluoride, or hydrofluoric acid (HF), is highly toxic to human beings and it can be highly corrosive. The toxicity of hydrofluoric acid to human beings is further complicated by the volatility of anhydrous hydrofluoric acid, which is typically a gas at normal atmospheric conditions of one atmosphere pressure and 70° F. It is possible due to the high vapor pressure of hydrofluoric acid at standard atmospheric conditions for a hydrofluoric acid spill to create certain safety concerns when it is exposed to the atmosphere. These safety concerns are created by the ease with which hydrofluoric acid is vaporized and released into the atmosphere. One particular safety concern is in the transportation of hydrofluoric acid; specifically, the concern is over the possibility of an accidental release into the atmosphere of hydrofluoric acid during its transport.

Anhydrous and aqueous hydrogen fluoride are typically transported by means of closed containers under pressure and generally under a blanket of pressurized nitrogen gas. This pressurization provides the benefit of keeping the HF in the liquid state during transportation, but it can have adverse consequences in the event of a liquid leak in the container. Thus, it is desirable to minimize the HF container pressure so as to reduce the pressure differential between the atmosphere and the container inside to thereby reduce the rate of HF escape into the atmosphere in the event of a container leak.

### SUMMARY OF THE INVENTION

It is, therefore, an object of this invention to improve the safety in the handling and transportation of hydrofluoric acid.

Another object of this invention is to provide a means by which HF can be stored or transported within a closed volume or closed container under a pressure that is significantly lower than has been conventionally used.

Yet another object of this invention is to provide for the confinement of HF under a pressure that is lower than the pressure conventionally used to store HF so as to minimize the pressure differential between the atmosphere and the confined space to thereby reduce or minimize the rate of escape into the atmosphere in the event of a containment leak.

Thus, the method of the present invention relates to the safe transportation of hydrogen fluoride from a point of origin to a desired destination. The improved transportation method includes adding at the point of origin a sulfone to the hydrogen fluoride to form a mixture. The mixture is then transported to the desired destination where the hydrogen fluoride and sulfone components are separated. The separated sulfone is returned to the point of origin for reuse as the hydrogen fluoride additive.

Another embodiment of the present invention includes receiving at a destination point a discrete volume of a mixture comprising hydrogen fluoride and sulfone by way of transportation means for transferring the discrete volume of the mixture from a point of origin to the destination point.

Still, another embodiment of the present invention includes transporting by transportation means for transferring a discrete volume of a mixture comprising hydrogen fluoride and sulfone from a point of origin to a destination point.

Yet another embodiment of the invention provides for the confinement of a liquid mixture comprising hydrogen fluoride and sulfolane within a closed volume or container wherein said liquid mixture fills less than the entire volume of said closed volume or container to thereby form a vapor space therein and wherein the partial pressure of hydrogen fluoride in said vapor space is less than the pure component vapor pressure of hydrogen fluoride.

### BRIEF DESCRIPTION OF THE DRAWINGS

Other objects and advantages of the invention will be apparent from the detailed description of the invention, the appended claims and the drawings in which:

FIG. 1 is a graphical diagram illustrating at a given temperature the change in vapor pressure of the hydrogen fluoride and sulfolane mixture of the invention as a function of the weight percent sulfolane in the mixture.

FIG. 2 provides a schematic representation of the improved transportation method.

### DETAILED DESCRIPTION OF THE INVENTION

Because of the high volatility of HF, its transportation can pose risks to the environment and nearby human beings in the event of an accidental release into the atmosphere. Typical means for transporting HF include, for example, the use of railroad tank cars, tank trucks, pipe lines and closed vessels or containers which contain HF. It is desirable to minimize the risk associated with a possible release of HF into the atmosphere. It is also desirable to lower the pressure within the shipping and storage vessels for HF below the conventionally used pressures so as to minimize the rate of release of HF into the atmosphere in the event of a liquid leak. The inventive method described herein provides for an improvement in the safety of the storage, handling and transportation of HF particularly in the transportation of discrete volumes of HF in closed vessels or containers.

An important aspect of the present invention is the ability to lower the vapor pressure of the HF being stored, handled or transported for the purpose of minimizing risk associated with such storage, handling or transportation. It has been discovered that the addition of a sulfone diluent to HF has the benefit of providing a resulting mixture having a lower vapor pressure than that of HF alone. It is the solubility of sulfone in HF which permits its mixing and thereby provide the benefit of lowering the vapor pressure of the HF that is being handled.

One advantage from using a sulfone in combination with HF to obtain a lower vapor pressure mixture for storage, handling and transportation is that a lesser amount of the HF will vaporize and enter into the atmosphere in cases where the mixture is accidentally exposed to the atmosphere. In particular, when making a comparison between the mixture and HF, one notices a significant difference in the vapor pressures of the two.

Another advantage from using the mixture of HF and sulfone is that a lower pressure is required to maintain the mixture in the liquid state when it is contained in a closed volume or vessel or container. This gives the benefit of lowering the pressure differential between the atmosphere and inside container.

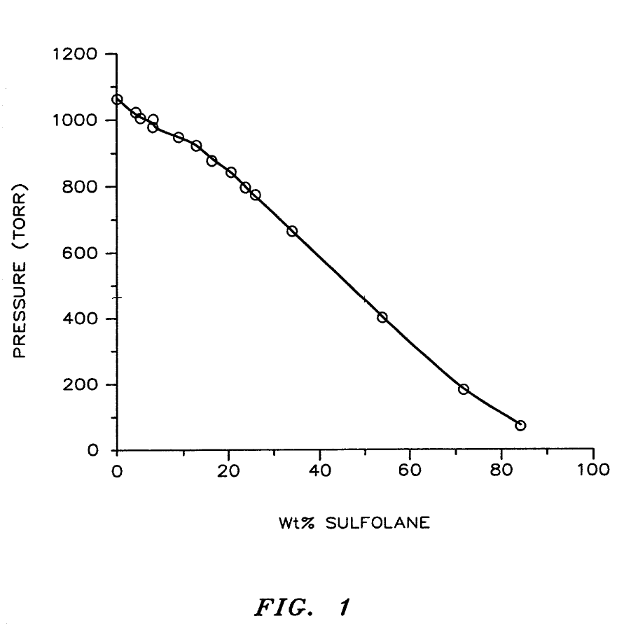

The effect of the presence of sulfolane mixed with hydrogen fluoride is illustrated in the vapor pressure plot of FIG. 1. Since hydrofluoric acid has a substantial vapor pressure at typical atmospheric or ambient conditions, it is often in a vapor state at such conditions, and this vapor pressure makes it a possibly less controllable compound in cases where it is exposed to the atmosphere or environment.

The vapor pressure benefit from adding a sulfone to HF in itself is not sufficient to warrant the combination sulfone and HF due to the need to separate the two components once the mixture has safely reached its destination. But, because of other unique physical properties of sulfone, it can be added to HF and subsequently separated with relative ease. The sulfone can easily be separated from the mixture of HF and sulfone due to the large difference between the relative volatilities of the two components. Therefore, because of the high solubility of sulfone in HF and the widely divergent relative volatilities of the two components, the addition of sulfone to HF can effectively lower its vapor pressure and enhance its storage and handling safety. Once the mixture has been delivered to its destination, the HF can easily be separated from the sulfone and used in its pure form as required.

A novel aspect of the instant invention includes utilizing the advantages of the physical properties of a sulfone by adding to HF that is to be transported a sulfone at a point of origin of the HF. The addition of the sulfone to the HF provides a resultant mixture having a vapor pressure substantially below that of HF alone. The mixture, having a reduced vapor pressure below that of HF, is transported to a desired destination. Once the mixture is safely transported to the desired destination, the components can be separated by any suitable means for separating the mixture into a sulfone phase and an HF phase. The sulfone phase can be returned to the point of origin where it can be reused as a diluent for the HF to be transported.

The sulfone components suitable for use in this invention are the sulfones of the general formula

R—SO₂—R′

wherein R and R′ are monovalent hydrocarbon alkyl or aryl substituents, each containing from 1 to 8 carbon atoms. Examples of such substituents include dimethylsulfone, di-n-propylsulfone, diphenylsulfone, ethylmethylsulfone and the alicyclic sulfones wherein the SO₂ group is bonded to a hydrocarbon ring. In such a case, R and R′ are forming together a branched or unbranched hydrocarbon divalent moiety preferably containing from 3 to 12 carbon atoms. Among the latter, tetramethylenesulfone or sulfolane, 3-methylsulfolane and 2,4-dimethylsulfolane are more particularly suitable since they offer the advantage of being liquid at process operating conditions of concern herein. These sulfones may also have substituents, particularly one or more halogen atoms, such as for example, chloromethylethylsulfone. These sulfones may advantageously be used in the form of mixtures.

The hydrogen fluoride component of this invention can be in anhydrous form, but, generally, the hydrogen fluoride component utilized can have a small amount of water. The amount of water present in the hydrogen fluoride and sulfone mixture in no event can be more than about 30 weight percent of the total weight of the hydrogen fluoride component, which includes the water, and preferably, the amount of water present in the hydrogen fluoride component is less than about 10 weight percent. Most preferably, the amount of water present in the hydrogen fluoride component is less than 5 weight percent. When referring herein to the hydrogen fluoride component, it should be understood that the term means either the hydrogen fluoride component as an anhydrous mixture or a mixture that includes water. The references herein to weight percent water contained in the hydrogen fluoride component means the ratio of the weight of water to the sum weight of the water and hydrogen fluoride multiplied by a factor of 100 to place the weight ratio in terms of percent.

The mixture formed by adding the sulfone to the HF at the point of origin of the HF will include the sulfone at a concentration suitable for providing a desired vapor pressure depressant effect. Generally, the weight ratio of the sulfone to HF of the mixture will be in the range of from about 1:100 to about 100:1. Preferably, the weight ratio will be in the range of from about 1:20 to about 20:1 and, most preferably, the weight ratio can be from 1:5 to 5:1.

The method by which the sulfone and HF mixture is transported can be any mode or means which suitably can be used to bulk transfer such a liquid mixture preferably in discrete volumes. Such suitable means are described at length in Perry's Chemical Engineer's Handbook, Sixth Edition, published by McGraw-Hill, Inc. 1984, at pages 6-110 through 6-113. Specifically, suitable transportation means for transferring a discrete volume of the liquid mixture include, for example, tank cars, tank trucks, and portable vessels such as tanks, drums, barrels, and bottles which are shipped by rail, ship, air or truck. The preferred transportation means is by tank car or by tank truck.

It is an important aspect of this invention to enhance the safety in transporting discrete volumes of HF across land, sea, and air by providing a liquid having physical properties that make it less likely to vaporize upon release to the atmosphere from a defined volume such as the previously described transportation means for transferring a discrete volume of a liquid mixture. The invention is not necessarily directed to the transportation of continuous volumes of the liquid mixture such as, for example, by pipeline. Rather, the invention is concerned with the movement or receipt of a fixed volume of the liquid mixture contained within a vessel having a definite volume which defines a fixed volume space. This movement of the liquid mixture is performed by placing a discrete volume or quantity of the liquid mixture into the transportation means for transporting a discrete volume of the liquid mixture and thereafter transporting it. This discrete volume can also be received at a desired location.

Once the mixture of sulfone and HF has reached its destination, the HF can be separated from the sulfone. The separated HF can be used as desired. Thus, the mixture undergoes a separation step whereby a sulfone phase is formed and a hydrogen fluoride phase is formed. Any suitable method can be used to separate the HF component from the sulfone component, such as, for example, flash separation, distillation, extraction, stripping, and other suitable separation methods. One method is by stripping means for separating the mixture into an overhead stream, comprising a major portion of the HF component of the mixture, and a bottoms stream, comprising a or portion of the sulfone component of the mixture, with the use of vaporous butane, which is preferably isobutane, as the stripping agent. A preferred method for separating the sulfone from the HF is by a single-stage, equilibrium-flash process to produce a sulfone phase and an HF phase. The wide divergence in the boiling temperatures of the two components of HF and sulfone makes feasible the use of flash separation means and the overall method for the safe transportation of hydrogen fluoride.

In some circumstances, due to the need to have a reasonably high purity hydrogen fluoride material for use in certain manufacturing processes and due to the recycling or reuse of the separated sulfone, having a high purity separated sulfone is not necessarily as important as having a high purity hydrogen fluoride. Thus, in the situation where a high purity hydrogen fluoride phase is required it will comprise hydrogen fluoride and contain a weight ratio of sulfone to hydrogen fluoride of less than about 2:100. Preferably, the weight ratio of sulfone to hydrogen fluoride in the hydrogen fluoride phase can be less than about 1:100 and, most preferably, it is less than 1:200.

It is not necessary for the sulfone phase to be substantially free of HF due to its reuse as an additive with HF prior to the transportation of the resultant mixture. Therefore, the sulfone phase comprises sulfone and can contain hydrogen fluoride at a concentration of less than about 20 weight percent based on the total weight of the sulfone phase. Preferably, the sulfone phase can contain less than about 10 weight percent hydrogen fluoride and, mostpreferably, less than 5 weight percent hydrogen fluoride.

In another embodiment of the invention, the mixture of HF and sulfone is contained within a closed volume or container. An important aspect of this invention is the containment of the mixture of HF and sulfone in the closed volume or container under pressure so as to maintain the mixture substantially in the liquid phase. Less than the entire volume of the closed volume or container is filled with the liquid mixture of HF and sulfone thereby providing for a vapor space. The vapor space is pressurized preferably with an inert gas such as nitrogen. One reason for pressurizing the vapor space with the inert gas is to keep oxygen gas out of the container; since, oxygen with hydrogen fluoride is highly corrosive to most of the common metals used to store and transport hydrogen fluoride. A positive pressure inside the container vessel assures that oxygen or air does not leak to the inside of the container vessel. However, as earlier described herein, it is desirable to minimize the required pressure within the container. The use of the sulfone diluent or additive allows for a reduction in the required pressure within the closed volume container below the pressures which have conventionally been used for HF confinement but without a resultant increase in the partial pressure of HF in the vapor space. Thus, the partial pressure of HF in the vapor space of the closed volume containing the liquid mixture comprising HF and sulfone at a given temperature is generally less than the vapor pressure of hydrogen fluoride at the same given temperature. Also, the percent partial pressure of the hydrogen fluoride in the vapor space can be less than 100 molar percent.

The liquid mixture of HF and sulfone confined within the closed volume vessel will have a weight ratio of sulfone to HF generally in the range of from about 1:100 to about 100:1. Preferably, the weight ratio will be in the range of from about 1:20 to about 20:1 and, most preferably, the weight ratio can be from 1:5 to 5:1.

The temperature of the liquid mixture confined within the closed volume generally approaches the ambient temperature. Preferably, the temperature of the liquid mixture is in the range of from about -10° F. to about 130° F., and, most preferably, the temperature is in the range of from about 20° F. to about 110° F.

Because it is desirable to minimize the pressure within the vapor space of the closed volume while still maintaining the advantages that derive from using a container under pressure, the pressure within the vapor space should be less than about 100 psig but exceeding atmospheric pressure. It is particularly desirable to keep the pressure within the vapor space less than the pressures generally used to store or transport HF either in the anhydrous form or in the aqueous form. Therefore, it is preferable for the vapor space pressure to exceed atmospheric pressure but being less than about 50 psig and, most preferably, the vapor space pressure can exceed atmospheric pressure but being less than 30 psig.

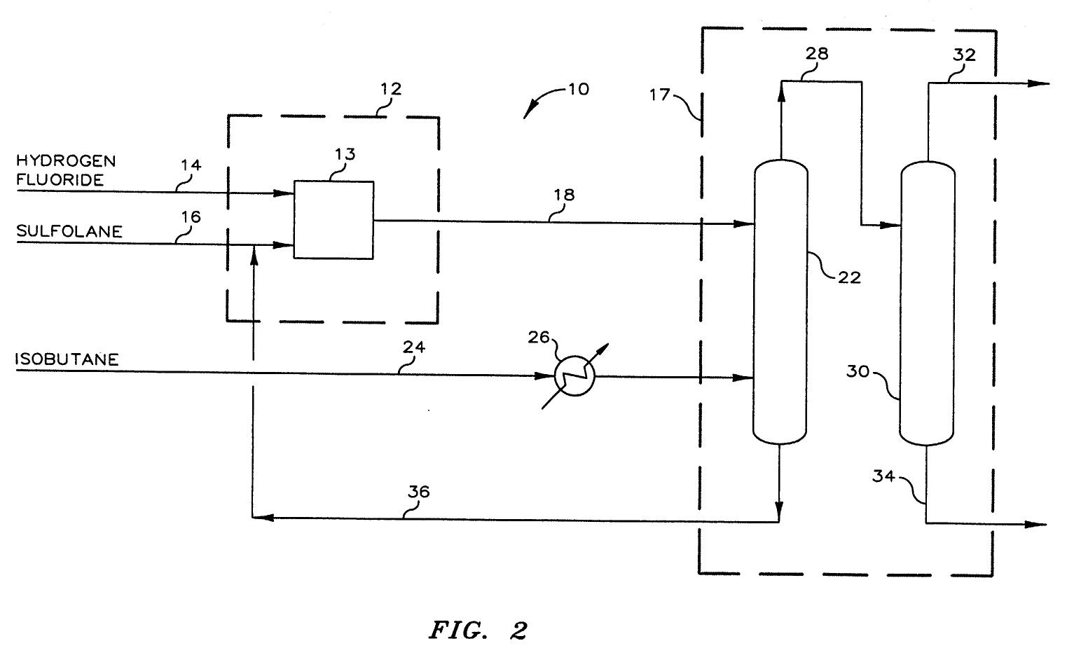

Now referring to FIG. 2, there is depicted a schematic representation of the improved method or process 10 for transporting hydrogen fluoride. At point of origin 12, hydrogen fluoride is conveyed to mixing device 13 by way of conduit 14. Sulfolane is conveyed to mixing device 13 through conduit 16. Mixing device 13 provides for the addition of sulfolane to hydrogen fluoride and for the mixing thereof to form a homogeneous mixture. Thus, mixing device 13 can be any suitable mechanical device, such as, for example, an in-line mixer and a blender. Mixing device 13 defines an adding or mixing zone wherein the components of sulfolane and hydrogen fluoride are added or mixed together to form a homogeneous mixture. The point of origin 12 is the physical location at which the sulfolane and hydrogen fluoride components are combined prior to the conveyance or shipping or transportation of the resulting mixture to a desired location 17.

The point of origin 12 can be a physical location from which hydrogen fluoride must be transported, and, generally, can be a production or manufacturing facility or a storage facility or any other location at which there can be found a volume of hydrogen fluoride. The desired location 17 is a point or place to which it is desired to transfer a volume of hydrogen fluoride.

The mixture comprising sulfolane and hydrogen fluoride is transported or conveyed by any suitable transportation means 18 to the desired destination or location 17. Such suitable transportation means 18 can include, for example, tank cars, tank trucks or even manual methods for the transportation of discrete volumes of liquid.

Once the mixture of sulfolane and hydrogen fluoride has reached the desired destination 17, the hydrogen fluoride is separated from the sulfolane. One method for separating the mixture of sulfolane and hydrogen fluoride into a sulfone phase and a hydrogen fluoride phase is to utilize stripping column 22, which defines a separation zone and provides means for separating sulfolane from hydrogen fluoride. Stripping isobutane is introduced into stripping column 22 by way of conduit 24. Interposed in conduit 24 is heat exchanger 26, which defines a heat transfer zone and provides means for transferring heat energy to the stripping isobutane, preferably, to vaporize the stripping isobutane prior to introducing it into stripping column 22. Thus, stripping column 22 produces an overhead stream, which comprises hydrogen fluoride and isobutane, and a bottoms stream, which comprises sulfolane.

The overhead stream passes from stripping column 22 through conduit 28 and can be utilized as is or can be transferred to separation column 30 whereby the hydrogen fluoride and isobutane are separated. Separation column 30 defines a separation zone and provides means for separating the overhead stream from stripping column 22 into a second overhead stream comprising isobutane and a second bottoms stream comprising hydrogen fluoride. The second overhead stream passes from separation column 30 by way of conduit 32 and second bottoms stream passes from separation column 30 by way of conduit 34. The bottoms stream from stripping column 22 can be recycled or returned to the point of origin 12 by way of transportation means 36. As described elsewhere herein, transportation means 36 which can be any suitable transportation means such as, for example, pipe lines, tank cars, tank trucks and manual methods. The recycled bottoms stream is reused as an additive to mixing device 13.

A preferred alternative to the above-described separation of the sulfolane and hydrogen fluoride mixture into a sulfolane phase and a hydrogen fluoride phase includes the use of a single-stage, flash separation means whereby the mixture undergoes a single-stage, equilibrium-flash process for providing a sulfone phase and a hydrogen fluoride phase. The sulfone phase can be reused at the point of origin 12.

The following example is provided to further illustrate the present invention.

### EXAMPLE I

This example shows the effect of pressure on the amount of HF which will fall out to the ground in liquid form rather than vaporize into the atmosphere, i.e., “rain out”, in the event of an HF/sulfolane mixture release into the atmosphere from a closed pressurized vessel.

A test chamber was constructed which allowed the release of 250 to 400 pounds of HF mixtures. The data presented in Table 1 show the results of two such tests. In each test, about 300 pounds of an approximately 1:1 weight ratio of HF/sulfolane mixture was released through a ¼″ hole at 90° F. The percent rain out was determined by collecting the material which fell out of the air to the ground in catch pans, titrating the pan contents, and then relating the results to percent rain out.

TABLE 1
Release Characteristics of HF/Sulfolane ˜ 1:1 HF/S Ratio 90° F. ¼″
Diameter Hole

| | Pressure Differential = | Pressure Differential = |
|---|---|---|
| | 50 psi | 140 psi |
| Rain out, % | 70.5 | 58.4 |

These data show that the addition of sulfolane to HF in about 1:1 ratio by weight will allow about 70 percent of the HF to fall to the ground, where it can be contained and neutralized in the event of an unplanned release. For anhydrous HF, greater than 80 percent of the released material formed a dense vapor cloud and aerosol which traveled downwind of the release point (see HF Study, Final Report to Congress, US EPA, EPA 550-R-93-001, September 1993, pages 12-15).

The data in Table 1 clearly show the benefit derived from the addition of sulfolane to HF to reduce airborne HF concentrations during a release. The data also show the benefit of lower pressure differential on HF rain out. The lower pressure drop through the release point allows more HF to rain out to the ground as opposed to vaporization into the atmosphere. Thus, HF can be contained at a lower pressure than HF alone due to vapor pressure suppression effects of sulfolane. Using this novel method of HF containment will reduce the levels of airborne HF in the event of a leak or an accidental release to the atmosphere.

While this invention has been described in terms of the presently preferred embodiment, reasonable variations and modifications are possible by those skilled in the art. Such variations and modifications are within the scope of the described invention and the appended claims.

That which is claimed:

1. A method for the transportation of hydrogen fluoride from a point of origin to a destination point, said method comprising the steps of:
adding at said point of origin a sulfone to the hydrogen fluoride to form a mixture;
thereafter transporting by transportation means for transferring said mixture from said point of origin to said destination point, said transportation means is selected from the group consisting of tank cars, tank trucks and portable vessels.

2. A method as recited in claim 1, further comprising:
separating at said destination point said mixture into a sulfone phase and a hydrogen fluoride phase.

3. A method as recited in claim 2 wherein said sulfone phase comprises sulfone and contains less than about 20 weight percent hydrogen fluoride.

4. A method as recited in claim 3 wherein said hydrogen fluoride phase comprises hydrogen fluoride and contains a weight ratio of sulfone to hydrogen fluoride of less than about 2:100.

5. A method as recited in claim 4, further comprising:
returning said sulfone phase to said point of origin to reuse as said sulfone.

6. A method as recited in claim 5 wherein said mixture includes a weight ratio of sulfone to hydrogen fluoride in the range of from about 1:100 to about 100:1.

7. A method for handling and transportation of hydrogen fluoride, said method comprising the step of:
receiving at a destination point a volume of a mixture comprising hydrogen fluoride and sulfone by way of transportation means for transferring said volume from a point of origin to said destination point, said transportation means is selected from the group consisting of tank cars, tank trucks and portable vessels.

8. A method as recited in claim 7, further comprising:
separating at said destination point said mixture into a sulfone phase and a hydrogen fluoride phase.

9. A method as recited in claim 8, further comprising:
returning said sulfone phase to said point of origin; and
adding at said point of origin said sulfone phase to hydrogen fluoride to form said mixture.

10. A method as recited in claim 9 wherein said mixture includes a weight ratio of sulfone to hydrogen fluoride in the range from about 1:100 to about 100:1.

11. A method as recited in claim 10 wherein said sulfone phase comprises sulfone and contains less than about 20 weight percent hydrogen fluoride.

12. A method as recited in claim 11 wherein said hydrogen fluoride phase comprises hydrogen fluoride and contains a weight ratio of sulfone to hydrogen fluoride of less than about 2:100.

13. A method for handling and transportation of hydrogen fluoride, said method comprising the step of:
transporting by transportation means for transferring a mixture comprising hydrogen fluoride and a sulfone from a point of origin to a destination point, said transportation means is selected from the group consisting of tank cars, tank trucks and portable vessels.

14. A method as recited in claim 13 wherein said mixture includes a weight ratio of sulfone to hydrogen fluoride in the range of from about 1:100 and 100:1.

15. A method as recited in claim 14, wherein said sulfone is sulfolane.

16. A method for the transportation of hydrogen fluoride from a point of origin to a destination point, said method comprising the steps of:
adding at said point of origin a sulfone to the hydrogen fluoride to form a mixture; and
thereafter transporting said mixture by transportation means for transferring a discrete volume of said mixture from said point of origin to said destination point.

17. A method as recited in claim 16 wherein said transportation means comprises tank cars, tank trucks, and portable vessels including tanks, drums, barrels and bottles.

18. A method as recited in claim 16 wherein said transportation means is a tank car.

19. A method as recited in claim 16 wherein said transportation means is a tank truck.

20. A method as recited in claim 16 wherein said transportation means is a portable vessel.

21. A method as recited in claim 16, further comprising:
separating at said destination point said mixture into a sulfone phase and a hydrogen fluoride phase.

22. A method as recited in claim 21, further comprising:
returning said sulfone phase to said point of origin to reuse as said sulfone.

23. A method as recited in claim 22 wherein said mixture includes a weight ratio of sulfone to hydrogen fluoride in the range of from about 1:100 about 100:1.

24. A method as recited in claim 23 wherein said sulfone phase comprises sulfone and contains less than about 20 weight percent hydrogen fluoride.

25. A method as recited in claim 24 wherein said hydrogen fluoride phase comprises hydrogen fluoride and contains a weight ratio of sulfone to hydrogen fluoride of less than about 2:100.

26. A method as recited in claim 17, further comprising:
separating at said destination point said mixture into a sulfone phase and a hydrogen fluoride phase.

27. A method as recited in claim 26, further comprising:
returning said sulfone phase to said point of origin to reuse as said sulfone.

28. A method as recited in claim 27 wherein said mixture includes a weight ratio of sulfone to hydrogen fluoride in the range of from about 1:100 about 100:1.

29. A method as recited in claim 28 wherein said sulfone phase comprises sulfone and contains less than about 20 weight percent hydrogen fluoride.

30. A method as recited in claim 29 wherein said hydrogen fluoride phase comprises hydrogen fluoride and contains a weight ratio of sulfone to hydrogen fluoride of less than about 2:100.

31. A method as recited in claim 18, further comprising:
separating at said destination point said mixture into a sulfone phase and a hydrogen fluoride phase.

32. A method as recited in claim 31, further comprising:
returning said sulfone phase to said point of origin to reuse as said sulfone.

33. A method as recited in claim 32 wherein said mixture includes a weight ratio of sulfone to hydrogen fluoride in the range of from about 1:100 about 100:1.

34. A method as recited in claim 33 wherein said sulfone phase comprises sulfone and contains less than about 20 weight percent hydrogen fluoride.

35. A method as recited in claim 34 wherein said hydrogen fluoride phase comprises hydrogen fluoride and contains a weight ratio of sulfone to hydrogen fluoride of less than about 2:100.

36. A method as recited in claim 19, further comprising:
separating at said destination point said mixture into a sulfone phase and a hydrogen fluoride phase.

37. A method as recited in claim 36, further comprising:
returning said sulfone phase to said point of origin to reuse as said sulfone.

38. A method as recited in claim 37 wherein said mixture includes a weight ratio of sulfone to hydrogen fluoride in the range of from about 1:100 about 100:1.

39. A method as recited in claim 38 wherein said sulfone phase comprises sulfone and contains less than about 20 weight percent hydrogen fluoride.

40. A method as recited in claim 39 wherein said hydrogen fluoride phase comprises hydrogen fluoride and contains a weight ratio of sulfone to hydrogen fluoride of less than about 2:100.

41. A method as recited in claim 20, further comprising:
separating at said destination point said mixture into a sulfone phase and a hydrogen fluoride phase.

42. A method as recited in claim 41, further comprising:
returning said sulfone phase to said point of origin to reuse as said sulfone.

43. A method as recited in claim 42 wherein said mixture includes a weight ratio of sulfone to hydrogen fluoride in the range of from about 1:100 about 100:1.

44. A method as recited in claim 43 wherein said sulfone phase comprises sulfone and contains less than about 20 weight percent hydrogen fluoride.

45. A method as recited in claim 44 wherein said hydrogen fluoride phase comprises hydrogen fluoride and contains a weight ratio of sulfone to hydrogen fluoride of less than about 2:100.

46. A method for handling and transportation of hydrogen fluoride, said method comprising the step of:
receiving at a destination point a discrete volume of a mixture comprising hydrogen fluoride and sulfone by way of transportation means for transferring said discrete volume from a point of origin to said destination point.

47. A method as recited in claim 46 wherein said transportation means includes tank cars, tank trucks, and portable vessels including tanks, drums, barrels and bottles.

48. A method as recited in claim 46 wherein said transportation means is a tank car.

49. A method as recited in claim 56 wherein said transportation means is a tank truck.

50. A method as recited in claim 56 wherein said transportation means is a portable vessel.

51. A method as recited in claim 46, further comprising:
separating at said destination point said mixture into a sulfone phase and a hydrogen fluoride phase.

52. A method as recited in claim 51 wherein said mixture includes a weight ratio of sulfone to hydrogen fluoride in the range of from about 1:100 to about 100:1.

53. A method as recited in claim 52 wherein said sulfone phase comprises sulfone and contains less than about 20 weight percent hydrogen fluoride.

54. A method as recited in claim 53 wherein said hydrogen fluoride phase comprises hydrogen fluoride and contains a weight ratio of sulfone to hydrogen fluoride of less than about 2:100.

55. A method as recited in claim 48, further comprising:
separating at said destination point said mixture into a sulfone phase and a hydrogen fluoride phase.

56. A method as recited in claim 55 wherein said mixture includes a weight ratio of sulfone to hydrogen fluoride in the range of from about 1:100 to about 100:1.

57. A method as recited in claim 56 wherein said sulfone phase comprises sulfone and contains less than about 20 weight percent hydrogen fluoride.

58. A method as recited in claim 57 wherein said hydrogen fluoride phase comprises hydrogen fluoride and contains a weight ratio of sulfone to hydrogen fluoride of less than about 2:100.

59. A method as recited in claim 49, further comprising:
separating at said destination point said mixture into a sulfone phase and a hydrogen fluoride phase.

60. A method as recited in claim 59 wherein said mixture includes a weight ratio of sulfone to hydrogen fluoride in the range of from about 1:100 to about 100:1.

61. A method as recited in claim 60 wherein said sulfone phase comprises sulfone and contains less than about 20 weight percent hydrogen fluoride.

62. A method as recited in claim 61 wherein said hydrogen fluoride phase comprises hydrogen fluoride and contains a weight ratio of sulfone to hydrogen fluoride of less than about 2:100.

63. A method as recited in claim 50, further comprising:
separating at said destination point said mixture into a sulfone phase and a hydrogen fluoride phase.

64. A method as recited in claim 63 wherein said mixture includes a weight ratio of sulfone to hydrogen fluoride in the range of from about 1:100 to about 100:1.

65. A method as recited in claim 64 wherein said sulfone phase comprises sulfone and contains less than about 20 weight percent hydrogen fluoride.

66. A method as recited in claim 65 wherein said hydrogen fluoride phase comprises hydrogen fluoride and contains a weight ratio of sulfone to hydrogen fluoride of less than about 2:100.

67. A method for handling and transportation of hydrogen fluoride, said method comprising the step of:
transporting a mixture comprising hydrogen fluoride and sulfone by transportation means for transferring a discrete volume of said mixture comprising hydrogen fluoride and sulfone from the point of origin to a destination point.

68. A method as recited in claim 67 wherein said transportation means includes tank cars, tank trucks, and portable vessels including tanks, drums, barrels and bottles.

69. A method as recited in claim 67 wherein said transportation means is a tank car.

70. A method as recited in claim 67 wherein said transportation means is a tank truck.

71. A method as recited in claim 67 wherein said transportation means is a portable vessel.

72. A method as recited in claim 67 wherein said mixture includes a weight ratio of sulfone to hydrogen fluoride in the range of from about 1:100 to about 1:100.

73. A method as recited in claim 72 wherein said sulfone is sulfolane.

74. A method as recited in claim 68 wherein said mixture includes a weight ratio of sulfone to hydrogen fluoride in the range of from about 1:100 to about 1:100.

75. A method as recited in claim 74 wherein said sulfone is sulfolane.

76. A method as recited in claim 69 wherein said mixture includes a weight ratio of sulfone to hydrogen fluoride in the range of from about 1:100 to about 1:100.

77. A method as recited in claim 76 wherein said sulfone is sulfolane.

78. A method as recited in claim 70 wherein said mixture includes a weight ratio of sulfone to hydrogen fluoride in the range of from about 1:100 to about 1:100.

79. A method as recited in claim 78 wherein said sulfone is sulfolane.

80. A method as recited in claim 71 wherein said mixture includes a weight ratio of sulfone to hydrogen fluoride in the range of from about 1:100 to about 1:100.

81. A method as recited in claim 80 wherein said sulfone is sulfolane.

82. A closed volume containing a liquid mixture comprising hydrogen fluoride and sulfone wherein said liquid mixture fills less than the entire volume of said closed volume to form a vapor space therein and wherein the percent partial pressure of hydrogen fluoride in said vapor space is less than 100 molar percent.

83. A closed volume as recited in claim 82 wherein the weight ratio of sulfone to hydrogen fluoride in said liquid mixture is in the range of from about 1:100 to about 100:1.

84. A closed volume as recited in claim 83 wherein the temperature of the liquid mixture is in the range of from about −10° F. to about 130° F.

85. A closed volume as recited in claim 84 wherein the pressure within said vapor space is less than about 100 psig.

86. A closed volume as recited in claim 85 wherein the sulfone of said liquid mixture is sulfolane.

87. A closed volume containing a liquid mixture comprising hydrogen fluoride and sulfone wherein said liquid mixture fills less than the entire volume of said closed volume to form a vapor space therein and wherein the partial pressure of hydrogen fluoride in said vapor space is less than the vapor pressure of hydrogen fluoride.

88. A closed volume as recited in claim 87 wherein the weight ratio of sulfone to hydrogen fluoride in said liquid mixture is in the range of from about 1:100 to about 100:1.

89. A closed volume as recited in claim 88 wherein the temperature of the liquid mixture is in the range of from about −10° F. to about 130° F.

90. A closed volume as recited in claim 89 wherein the pressure within said vapor space is less than about 100 psig.

91. A closed volume as recited in claim 90 wherein the sulfone of said liquid mixture is sulfolane.
